(19) United States
(12) Patent Application Publication
(10) Pub. No.: US 2025/0225276 A1
(43) Pub. Date: Jul. 10, 2025

(54) MACSEC-LIKE ENCRYPTION FOR BLANKET OBFUSCATION AND ENHANCED PRIVACY CONTENT

(71) Applicant: Cisco Technology, Inc., San Jose, CA (US)

(72) Inventors: Domenico Ficara, Essertines-sur-Yverdon (CH); Ugo Mario Campiglio, Morges (CH); Jerome Henry, Pittsboro, NC (US); Javier I. Contreras Albesa, Sant Cugat del Valles (ES); Stephen Michael Orr, Wallkill, NY (US)

(21) Appl. No.: 18/981,948

(22) Filed: Dec. 16, 2024

Related U.S. Application Data
(60) Provisional application No. 63/618,965, filed on Jan. 9, 2024.

(51) Int. Cl. G06F 21/62; G06F 21/60

(52) U.S. Cl. CPC G06F 21/6254; G06F 21/602

(57) ABSTRACT

Presented herein are techniques to obfuscate privacy related fields of a data unit. A data unit that includes a header and a data payload is obtained. An encryption operation is performed on the data unit to encapsulate the data payload and at least a portion of the header in an encrypted payload. A frame that includes the encrypted payload is wirelessly transmitted.

### CROSS REFERENCE TO RELATED APPLICATION

This application claims priority to U.S. Application No. 63/618,965, filed Jan. 9, 2024, the entirety of which is incorporated herein by reference.

### TECHNICAL FIELD

The present disclosure relates to secure wireless networking.

### BACKGROUND

The Institute of Electrical and Electronics Engineers (IEEE) 802.11bi standard aims to provide clients with the ability to avoid being tracked in a wireless network. To prevent being tracked, any observable parameter or header field that helps in tracking a certain station or client is to be obfuscated. Any approach to obfuscate a given parameter is valid only as long as all the rest of the privacy correlated parameters are also obfuscated with the same level of anonymity.

### BRIEF DESCRIPTION OF THE DRAWINGS

FIG. 1 is a high-level diagram of a wireless network in which the techniques presented herein may be employed, according to an example embodiment.

FIG. 2 is a diagram showing the encrypted and unencrypted portions of an IEEE 802.11 frame, according to example embodiments.

FIG. 3 is diagram of a Media Access Control (MAC) security (MACsec) frame in which an MPDU is encapsulated in a payload of the MACsec frame, according to example embodiments.

FIGS. 4A and 4B illustrate examples of MACsec frames in which a MACsec header is extended to include certain portions of the MPDU header that remain unencrypted, according to an example embodiment.

FIG. 5 is a flow diagram of a method of performing an encryption operation on a data unit to encapsulate the data unit in an encrypted payload, according to an example embodiment.

FIG. 6 illustrates a hardware block diagram of device that may perform functions associated with operations presented herein, according to an example embodiment.

### DETAILED DESCRIPTION

### Overview

In one embodiment, a method is provided to encrypt a data unit to obfuscate privacy related fields of the data unit. The method includes obtaining a data unit that includes a header and a data payload. An encryption operation is performed on the data unit to encapsulate the data payload and at least a portion of the header in an encrypted payload, and a frame that includes encrypted payload is wirelessly transmitted.

### EXAMPLE EMBODIMENTS

As discussed above, to avoid being tracked in a wireless network, any observable parameters or header fields that help in tracking a particular station should be obfuscated. For example, the over-the-air (OTA) Media Access Control (MAC) address field, the Association Identifier (AID) field, the Traffic Identifier (TID) field, and additional fields may include privacy related information that may be used to track stations. One main topic in the IEEE 802.11bi group is MAC address rotation, but interest is growing on the other observable parameters and how to obfuscate them. Each parameter carries a different amount of information and is currently treated as a separate problem. However, to prevent tracking, all privacy related fields should be obfuscated or encrypted.

Presented herein are techniques to adopt a blanket mechanism to encrypt all of an IEEE 802.11 frame (including portions or all of the header) to avoid having a mix of ad-hoc solutions for each parameter and to rely on state-of-the-art encryption techniques. In particular, embodiments described herein provide for encrypting a data unit so that the data payload and portions or all of the header of the data unit are encapsulated in an encrypted payload. For example, a MACsec operation may be performed on a data unit, such as a MAC protocol data unit (MPDU), to encapsulate the MPDU in a MACsec payload. By encapsulating the data unit (including privacy related fields of the header) in an encrypted payload, the privacy related fields of the header are encapsulated in the encrypted payload and are obfuscated.

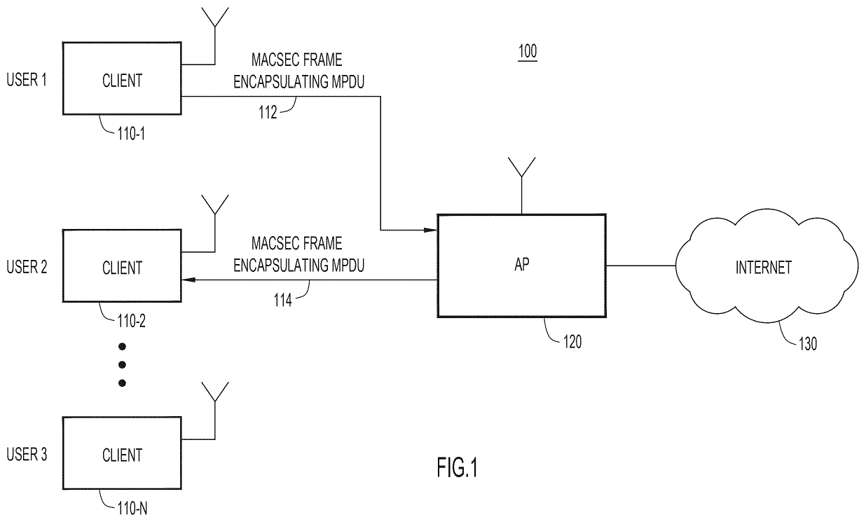

FIG. 1 is a high-level diagram showing a wireless network 100 that includes a plurality of wireless clients or stations (STAs) 110-1, 110-2, . . . 110-N and a wireless access point (AP) 120 that has a wired connection to a network, such as the Internet 130. The AP 120 and wireless clients 110-1 to 110-N communicate with each other using a wireless communication standard, such as the IEEE 802.11 wireless local area network (WLAN) standard. Although only one AP 120 is illustrated in FIG. 1, wireless network 100 may include multiple APs that communicate with one another and with wireless clients to transmit information.

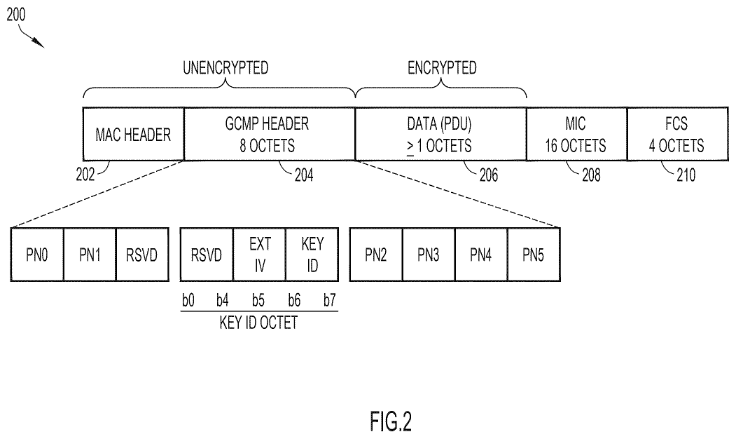

Traditionally, wireless clients 110-1 to 110-N communicate by exchanging data units, such as MPDUs. It is advantageous to avoid tracking of the data units exchanged in the wireless network to ensure the privacy of sensitive information. In IEEE 802.11, encryption is supported for the payload, but not for the header of the data unit, as illustrated in FIG. 2.

Reference is now made to FIG. 2. FIG. 2 is a diagram showing the encrypted and unencrypted portions of an IEEE 802.11 frame or MPDU. FIG. 2 illustrates a format of an MPDU 200 when using the Galois Counter Mode Protocol (GCMP). As illustrated in FIG. 2, MPDU 200 includes a MAC header 202, a GCMP header 204, data 206, Message Integrity Code (MIC) field 208, and Frame Check Sequence (FCS) field 210.

MAC header 202 may include information associated with the MPDU 200, such as a destination MAC address that indicates the address of the intended recipient, a source MAC address that indicates the address of the sending device or STA, a frame control field that indicates the frame type and subtype, sequence control information, duration/ID field, and possibly additional information. The GCMP header 204 encodes the packet number (PN), Key ID, and Extended Initialization Vector (ExtIV) field values used to encrypt the data 206 of the MPDU. As illustrated in FIG. 2, the MAC header 202 and the GCMP header 204 are unencrypted.

The data 206 includes the information that is being transmitted from the source station to the destination station. As illustrated in FIG. 2, the data 206 is encrypted. In particular, the data 206 is encrypted using the GCMP.

The MIC field 208 includes a few bytes that are added to the data unit to make the data unit tamper-proof. The FCS field 210 contains a number that is calculated by the source station based on the data in the frame. When the destination station receives the frame, the FCS number is recalculated and compared with the FCS number included in the frame to ensure that the numbers match.

The payload/data 206 and the MAC header 202 of MPDU 200 may include sensitive information. For example, the MAC header 202 includes privacy related fields, such as the destination MAC address and the source MAC address, that may be used to track the client. As described above, in IEEE 802.11, encryption is supported for the payload (e.g., data 206), but the information in MAC header 202 is not encrypted. Therefore, privacy related fields in the MAC header 202 may be used to track the client.

Embodiments presented herein provide for encrypting the privacy related fields of the MAC header 202. In particular, some embodiments presented herein provide for encapsulating the entire MPDU 200, including the entire header, in an encrypted payload to obfuscate the privacy related fields that were previously unencrypted (e.g., the privacy related fields in the MAC header). Other embodiments presented herein provide for encapsulating the MPDU 200, including privacy related portions of the header, in an encrypted payload. In these embodiments, portions of the header of the MPDU 200 that are not encapsulated in the encrypted payload may be added as a header to the encrypted payload and may remain unencrypted.

MACsec, as described in IEEE 802.1AE, is a standard for security that has been designed to work on Ethernet networks in which encryption is not present. MACsec introduces a header (identified by a special header type: 0x88e5) that includes a length of the encrypted data, a packet number (to avoid replay), and an optional channel identifier.

When performing MACsec, encryption is performed with Advanced Encryption Standard-Galois Counter Mode (AES-GCM), which is similar to the GCMP in IEEE 802.11 described above. MACsec uses AES-GCM cryptography to encrypt data and adds a security tag and integrity check value to each Ethernet frame.

The techniques presented herein involve adapting MACSec to IEEE 802.11 to encrypt the privacy related fields of a MAC header. In particular, embodiments provided herein provide for encapsulating the MPDU 200, including all of the header or portions of the header, within a MACsec payload.

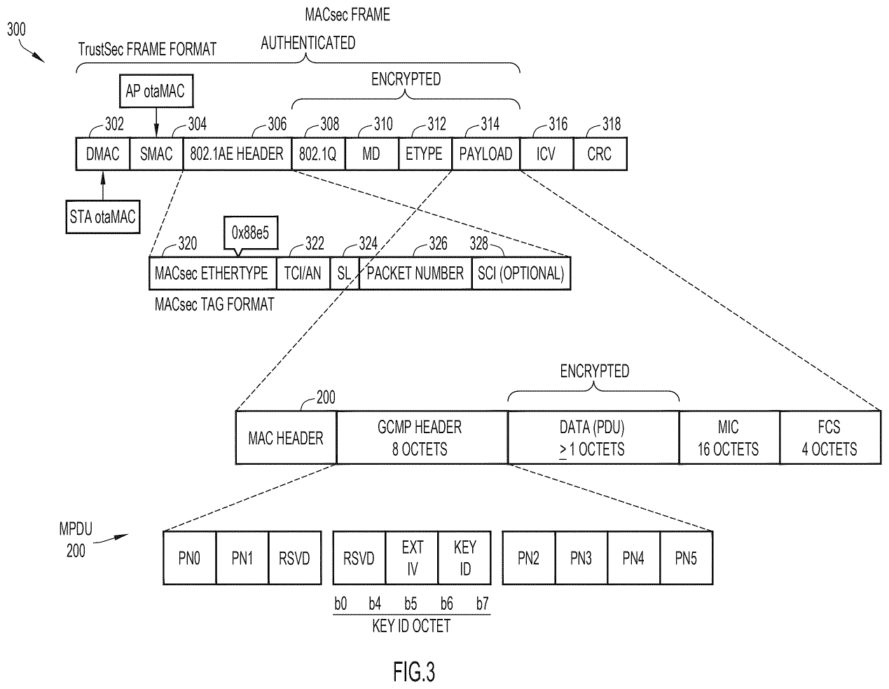

Reference is now made to FIG. 3. FIG. 3 is diagram of a MACsec frame 300 in which MPDU 200 is encapsulated in a payload of the MACsec frame 300. MACsec frame 300 includes a destination MAC address (DMAC) field 302, a source MAC address (SMAC) field 304, an 802.1AE header field 306, an 802.1Q field 308, a metadata field 310, an EtherType (Etype) field 312, payload 314, Integrity Check Value (ICV) field 316, and Cycle Redundancy Check (CRC) field 318. The 802.1AE header field 306 includes MACsec EtherType field 320, Tag Control Information (TCI)/Association Number (AN) field 322, Short Length (SL) field 324, Packet Number field 326, and an optional Secure Channel Identifier (SCI) field 328.

As illustrated in FIG. 3, all of the fields of the MACsec frame 300 are authenticated. The information in the ICV field 316 is used to authenticate the fields before the CRC field 318. In addition, as shown in FIG. 3, all fields after the 802.1AE header field 306 are encrypted, which obfuscates fields, such as MPLS labels 802.1P and 802.1Q from the original Ethernet frame. Therefore, any intermediate network device that may require those tags are not able to see them.

In one embodiment, MACsec is performed on top of the entire 802.11 frame (e.g., MPDU 200), encapsulating the full MPDU 200 within MACsec payload 314. The DMAC field 302 and the SMAC field 304 include privacy related information that may be used to track the MACsec frame 300. Therefore, in this approach, the source MAC address may be replaced with the otaMAC address of the AP and the destination MAC address may be replaced with the otaMAC address of the destination STA. These are defined in IEEE 802.11bi and may be rotated.

In this embodiment, instead of the source address (SA) and destination address (DA) being visible, the OTA MACs are the transmitting address (TA) and receiving address (RA). The SA and DA are obfuscated by MACsec. In other words, the source address and the destination address in the MAC header 202 are obfuscated because the entire MPDU 200 (including the information in the MAC header 202) is encrypted and encapsulated in the MACsec frame 300.

The full 802.11 header will not be visible in this embodiment, which means encapsulating the entire MPDU 200 (including the entire header) in the MACsec payload is not backwards compatible with non-IEEE 80211.bi compliant stations. IEEE 802.11bi is accepting breaking backwards compatibility as an expected outcome, so obfuscation is acceptable and within the scope of IEEE 802.11bi.

To help support backwards compatibility, in some embodiments, instead of encapsulating the entire MPDU 200 (including the entire header) in a MACsec frame, portions of the header of the MPDU 200 may be encrypted in the MACsec frame and other portions of the header may not be encrypted. For example, some portions of the MPDU header may be added to the header of the MACsec frame and may remain unencrypted.

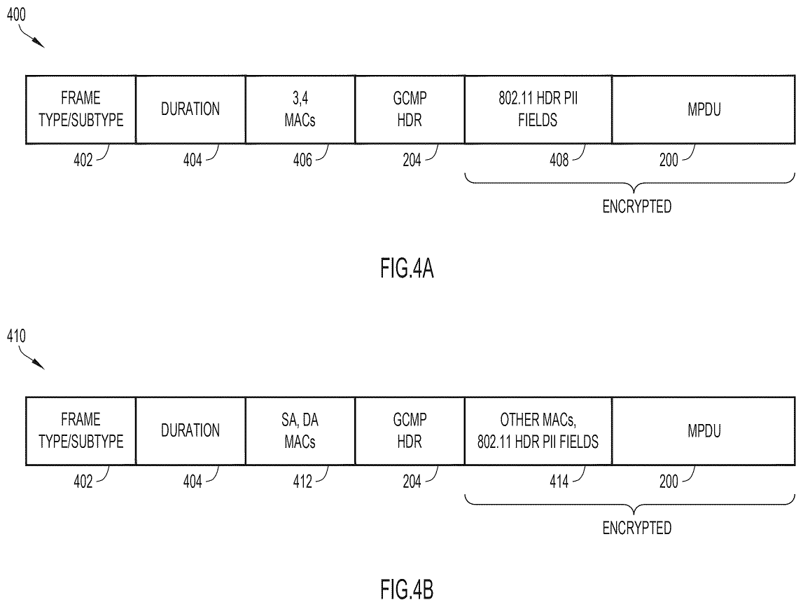

Reference is now made to FIGS. 4A and 4B. FIGS. 4A and 4B illustrate examples of MACsec frames in which the MACsec header is extended to include certain portions of the header of MPDU 200 that are not encrypted. In the examples illustrated in FIGS. 4A and 4B, instead of encapsulating the entire MPDU header in the MACsec payload, portions (e.g., privacy related portions) of the MPDU header are encapsulated in the MACsec payload 314 and other portions of the MPDU header are added to the (unencrypted) header of the MACsec frame 300.

In the example illustrated in FIG. 4A, the MACsec header of MACsec frame 400 is extended to include a frame type/subtype field 402 (16 bits), a duration field 404, three or four MAC headers field 406, and the GCMP header 204 from MPDU 200. In this embodiment, the three or four MAC headers may include the SA, DA, TA, and RA. The SA and DA may be non-relevant (e.g., randomly generated) values because the RA does not need the SA and the DA to receive the frame, and the real values of the SA and the DA are within the MACsec payload 314.

In the example illustrated in FIG. 4A, the information in the GCMP header 204 is preserved and not encrypted, which helps support backwards compatibility. In other words, the GCMP header 204 and some of the MAC addresses of MPDU 200 are not encapsulated in the MACsec payload and are, instead, added to the MACsec header and remain unencrypted. As illustrated in FIG. 4A, the rest of the 802.11 header fields of the MPDU 200 are encrypted and included in the 802.11 header (hdr) Personally Identifiable Information (PII) field 408 and the payload of the MPDU 200 is encrypted.

FIG. 4B illustrates a MACsec frame 410 that is a variation of MACsec frame 400 shown in FIG. 4A. In MACsec frame 410, two of the MAC addresses, SA and DA, from MAC header 202 are unencrypted, as illustrated in the SA, DA MAC field 412. The rest of the MAC addresses from MAC header 202 are encrypted and included in field 414 with other 802.11 headers.

Referring back to FIG. 3, the IEEE 802.1AE header field 306 contains a packet number for avoiding replay attacks. This number is also part of the GCMP header 204, so it can be removed from the 802.1AE header field 306. Regardless of where the packet number is introduced (802.1AE header field or GCMP header 204), it is desirable for the packet numbers to be nonconsecutive when a MAC address rotation occurs to avoid being tracked.

To avoid nonconsecutive packet number values when rotating MAC addresses, in one embodiment, the 802.1AE packet number may be a random value. An IEEE 802.11 compliant device may detect duplicated addresses when decoding the 802.11 MAC header. In another embodiment, the AP (e.g., AP 120) and the STA (e.g., wireless client 110-1 to 110-N) agree to reset this value when the MAC rotation takes place or to add an offset to the previous value.

In yet another embodiment, an 802.1AEdk scheme may be used. In particular, in this embodiment, a (protected) negotiation is allowed between the AP (e.g., AP 120) and the STA (e.g., wireless client 110-1 to 110-N) to define a common predetermined frame size. In most scenarios, the AP determines a frame size, and shares a value of the frame size with newly associated STAs. Then, the STA adds padding at the end of the payload segment, making all frames from all STAs look alike to an observer (a device that receives and decodes the frame). In another embodiment, padding may be an optional process. For example, in some situations, it may not be desirable to add padding due to increased radio frequency (RF) airtime utilization.

In the case in which padding is used, for additional privacy, the padding may be defined as a size range random distribution, proposed by the AP on a given size range. For example, the size range may be 300 to 1500 bytes. In this case, any STA transmitting a frame lower than a maximum size may select a random size selected from max ((max_frame_size-current_frame_size)+minimum, max_frame_size). Selecting the random size may make Encrypted Traffic Analysis for common characteristic flows (e.g., voice) more difficult, but would not excessively increase RF utilization due to all frames using maximum size.

Referring back to FIG. 1, wireless client 110-1 may wish to transmit information to wireless client 110-2. In this case, wireless client 110-1 may perform MACsec on top of the MPDU or 802.11 frame to encapsulate the MPDU within a MACsec payload. As discussed above, the entire header or portions of the header may be encapsulated within the MACsec payload. At 112, wireless client 110-1 may transmit the MACsec frame to AP 120. At 114, AP 120 may transmit the MACsec frame to client 110-2 and client 110-2 may decrypt the MACsec frame and the encapsulated 802.11 frame.

Although FIG. 1 illustrates the encryption and decryption being performed by the wireless clients 110-1 and 110-2, in some embodiments, AP 120 may perform the encryption and/or the decryption. For example, AP 120 may receive an 802.11 frame and perform MACsec on the 802.11 frame. In this example, AP 120 may transmit the MACsec frame to a client or to another access point for forwarding to a destination client. In another example, AP 120 may receive a MACsec frame from a client or another access point that is destined for a client that is not MACsec capable. In this case, AP 120 may perform decryption operations and transmit the decrypted frame to the destination client.

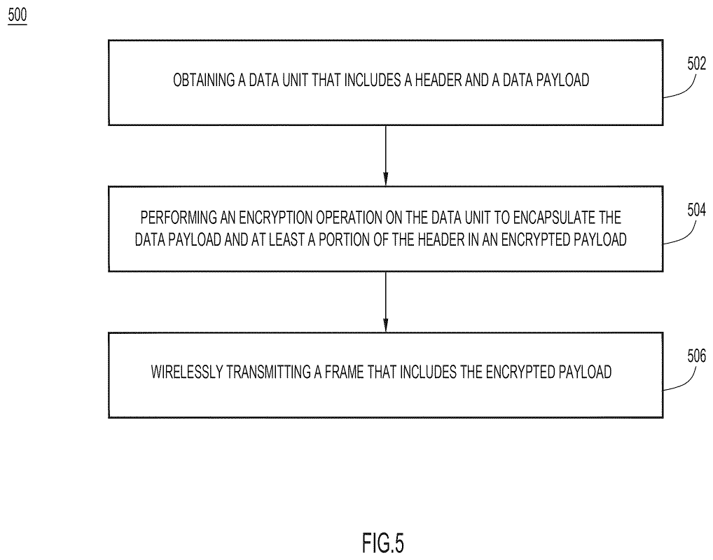

Reference is now made to FIG. 5. FIG. 5 is a flow diagram of a method 500 of performing an encryption operation on a data unit to encapsulate the data unit in an encrypted payload. At 502, a data unit is obtained. The data unit includes a header and a data payload. At 504, an encryption operation is performed on the data unit to encapsulate the data payload and at least a portion of the header in an encrypted payload. For example, the data unit may be an MPDU and a MACsec operation may be performed on the MPDU to encapsulate the MPDU in a MACsec payload of a MACsec frame. In some embodiments, the entire MPDU, including the header and the payload, may be encapsulated in the encrypted MACsec payload. In other embodiments, portions of the header of the MPDU may remain unencrypted and may be included in the header of the MACsec frame. At 506, a frame that includes the encrypted payload is wirelessly transmitted. For example, the MACsec frame may be transmitted to a device or node.

In summary, the techniques presented herein involve extending MACsec to support IEEE 802.11 for privacy reasons, which supports the scenarios envisioned in IEEE 802.11bi. By encapsulating the data unit or MPDU (including all or portions of the header) in a MACsec payload, the privacy related fields of a header of the data unit (e.g., source MAC address, destination MAC address, AID, TID, etc.) are obfuscated. Obfuscating privacy related fields of the data unit may prevent tracking of the client.

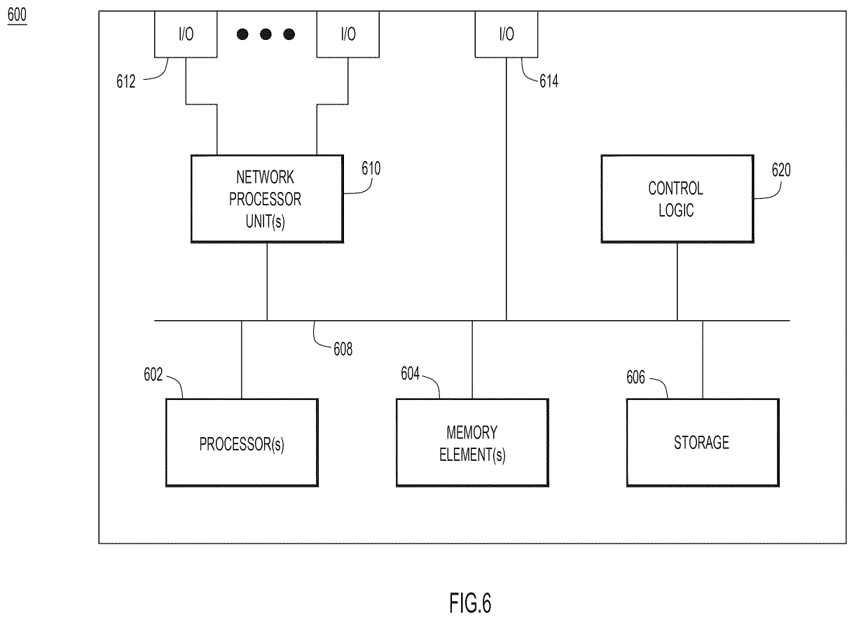

Referring to FIG. 6, FIG. 6 illustrates a hardware block diagram of device (e.g., AP 120 or client 110-1 to 110-N) that may perform functions associated with operations discussed herein in connection with the techniques depicted in FIGS. 1-3, 4A, 4B, and 5.

In at least one embodiment, the apparatus 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for apparatus 600 can overlap in any manner and are not limited to the specific allocation of instructions and/or operations described herein.

In at least one embodiment, processor(s) 602 is/are at least one hardware processor configured to execute various tasks, operations and/or functions for apparatus 600 as described herein according to software and/or instructions configured for apparatus 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with apparatus 600, and/or logic configured for memory element(s) 604 and/or storage 606. For example, any logic described herein (e.g., control logic 620) can, in various embodiments, be stored for apparatus 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of apparatus 600 to communicate in order to exchange information and/or data. Bus 608 can be implemented with any architecture designed for passing control, data and/or information between processors, memory elements/storage, peripheral devices, and/or any other hardware and/or software components that may be configured for apparatus 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between apparatus 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between apparatus 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to apparatus 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of apparatus; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to an apparatus for transfer onto another computer readable storage medium.

In one form, a method is provided that includes obtaining a data unit that includes a header and a data payload; performing an encryption operation on the data unit to encapsulate the data payload and at least a portion of the header in an encrypted payload; and wirelessly transmitting a frame that includes the encrypted payload.

In one example, performing the encryption operation includes encapsulating a source address and a destination address associated with the data unit in the encrypted payload. In another example, the data unit is a Media Access Control (MAC) protocol data unit (MPDU) and wherein performing the encryption operation includes performing a MAC security (MACsec) operation on the MPDU to encapsulate the MPDU within a MACsec payload. In another example, performing the MACsec operation on the MPDU includes adding a MACsec header to the MACsec payload, the MACsec header including an over-the-air MAC (otaMAC) address of a wireless client device as a destination address and an otaMAC address of a wireless access point device as a source address.

In another example, the MACsec header includes randomly generated values for a source address and a destination address. In another example, padding is added to the data payload so that a size of the data unit is a predetermined size, wherein the predetermined size is determined by an access point and wherein the padding is added by a wireless client device that is a source of the data unit. In another example, wirelessly transmitting includes wirelessly transmitting the frame according to an IEEE 802.11 wireless networking protocol.

In another form an apparatus is provided that includes a memory; a network interface configured to enable network communication; and a processor, wherein the processor is configured to perform operations including: obtaining a data unit that includes a header and a data payload; performing an encryption operation on the data unit to encapsulate the data payload and at least a portion of the header in an encrypted payload; and causing a frame that includes the encrypted payload to be wirelessly transmitted.

In another form, one or more non-transitory computer readable storage media encoded with instructions are provided that, when executed by a processor, cause the processor to execute a method including: obtaining a data unit that includes a header and a data payload; performing an encryption operation on the data unit to encapsulate the data payload and at least a portion of the header in an encrypted payload; and causing a frame that includes the encrypted payload to be wirelessly transmitted.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform] ing [a function] . . . or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a data unit that includes a header and a data payload;
performing an encryption operation on the data unit to encapsulate the data payload and at least a portion of the header in an encrypted payload; and
wirelessly transmitting a frame that includes the encrypted payload.

2. The method of claim 1, wherein performing the encryption operation includes encapsulating a source address and a destination address associated with the data unit in the encrypted payload.

3. The method of claim 1, wherein the data unit is a Media Access Control (MAC) protocol data unit (MPDU) and wherein performing the encryption operation comprises performing a MAC security (MACsec) operation on the MPDU to encapsulate the MPDU within a MACsec payload.

4. The method of claim 3, wherein performing the MACsec operation on the MPDU includes adding a MACsec header to the MACsec payload, the MACsec header including an over-the-air MAC (otaMAC) address of a wireless client device as a destination address and an otaMAC address of a wireless access point device as a source address.

5. The method of claim 4, wherein the MACsec header includes randomly generated values for a source address and a destination address.

6. The method of claim 1, wherein padding is added to the data payload so that a size of the data unit is a predetermined size, wherein the predetermined size is determined by an access point and wherein the padding is added by a wireless client device that is a source of the data unit.

7. The method of claim 1, wherein wirelessly transmitting comprises wirelessly transmitting the frame according to an IEEE 802.11 wireless networking protocol.

8. An apparatus comprising:
a memory;
a network interface configured to enable network communication; and
a processor, wherein the processor is configured to perform operations comprising:
obtaining a data unit that includes a header and a data payload;
performing an encryption operation on the data unit to encapsulate the data payload and at least a portion of the header in an encrypted payload; and
causing a frame that includes the encrypted payload to be wirelessly transmitted.

9. The apparatus of claim 8, wherein the operation of performing the encryption operation comprises encapsulating a source address and a destination address associated with the data unit in the encrypted payload.

10. The apparatus of claim 8, wherein the data unit is a Media Access Control (MAC) protocol data unit (MPDU) and wherein the operation of performing the encryption operation comprises performing a MAC security (MACsec) operation on the MPDU to encapsulate the MPDU within a MACsec payload.

11. The apparatus of claim 10, wherein performing the MACsec operation on the MPDU includes adding a MACsec header to the MACsec payload, the MACsec header including an over-the-air MAC (otaMAC) address of a wireless client device as a destination address and an otaMAC address of a wireless access point device as a source address.

12. The apparatus of claim 11, wherein the MACsec header includes randomly generated values for a source address and a destination address.

13. The apparatus of claim 8, wherein padding is added to the data payload so that a size of the data unit is a predetermined size, wherein the predetermined size is determined by an access point and wherein the padding is added by a wireless client device that is a source of the data unit.

14. The apparatus of claim 8, wherein the operation of wirelessly transmitting comprises wirelessly transmitting the frame according to an IEEE 802.11 wireless networking protocol.

15. One or more non-transitory computer readable storage media encoded with instructions that, when executed by a processor, cause the processor to execute a method comprising:
obtaining a data unit that includes a header and a data payload;
performing an encryption operation on the data unit to encapsulate the data payload and at least a portion of the header in an encrypted payload; and
causing a frame that includes the encrypted payload to be wirelessly transmitted.

16. The one or more non-transitory computer readable storage media of claim 15, wherein performing the encryption operation includes encapsulating a source address and a destination address associated with the data unit in the encrypted payload.

17. The one or more non-transitory computer readable storage media of claim 15, wherein the data unit is a Media Access Control (MAC) protocol data unit (MPDU) and wherein performing the encryption operation comprises performing a MAC security (MACsec) operation on the MPDU to encapsulate the MPDU within a MACsec payload.

18. The one or more non-transitory computer readable storage media of claim 17, wherein performing the MACsec operation on the MPDU includes adding a MACsec header to the MACsec payload, the MACsec header including an over-the-air MAC (otaMAC) address of a wireless client device as a destination address and an otaMAC address of a wireless access point device as a source address.

19. The one or more non-transitory computer readable storage media of claim 18, wherein the MACsec header includes randomly generated values for a source address and a destination address.

20. The one or more non-transitory computer readable storage media of claim 15, wherein wirelessly transmitting comprises wirelessly transmitting the frame according to an IEEE 802.11 wireless networking protocol.
